(19) United States
(12) Patent Application Publication
(10) Pub. No.: US 2026/0281202 A1
(43) Pub. Date: Sep. 17, 2026

(54) METHOD, APPARATUS, DEVICE, MEDIUM, AND PROGRAM PRODUCT FOR NOTIFICATION MESSAGE PUSH

(71) Applicant: Beijing Zitiao Network Technology Co., Ltd., Beijing (CN)

(72) Inventors: Yifan Yang, Beijing (CN); Yingdong Li, Beijing (CN); Lei Ma, Beijing (CN); Hailin Wen, Beijing (CN)

(21) Appl. No.: 19/449,821

(22) Filed: Jan. 15, 2026

(30) Foreign Application Priority Data
Jan. 15, 2025 (WO) PCT/CN2025/072603

(51) Int. Cl. H04L 67/55

(52) U.S. Cl. CPC H04L 67/55

(57) ABSTRACT

According to embodiments of the disclosure, a method, an appratus, a device, a medium and a program product for notification message push are provided. The method includes: determining, in response to a trigger for message display, whether a notification message is cached, the cached notification message remaining undisplayed for a target display period; determining, in response to determining that one or more notification message are cached, whether at least one of the one or more cached notification message satisfies a corresponding display rule; and performing push of the at least one notification message in response to determining that the at least one notification message satisfies the corresponding display rule.

### CROSS REFERENCE

This application claims priority to PCT Application No. PCT/CN2025/072603, filed on January 15, 2025 and entitled “METHOD, APPARATUS, DEVICE, MEDIUM, AND PROGRAM PRODUCT FOR NOTIFICATION MESSAGE PUSH”, the entirety of which is incorporated herein by reference.

### FIELD

Example embodiments of the disclosure generally relate to the field of computers, and in particular to a method, an apparatus, a device, a computer-readable storage medium, and a computer program product for notification message push.

### BACKGROUND

With the rapid development of mobile Internet, the use frequency of various client devices is getting higher and higher, and the demand for users to obtain information in time also increases. Accordingly, it is desirable to be able to transmit information related to a user to the user instantly and reliably through a client device. It is expected to provide a solution capable of reliably pushing a notification message to the client device.

### SUMMARY

In a first aspect of the disclosure, a method for notification message push is provided. The method includes: determining, in response to a trigger for message display, whether a notification message is cached, the cached notification message remaining undisplayed for a target display period; determining, in response to determining that one or more notification messages are cached, whether at least one of the one or more cached notification messages satisfies a corresponding display rule; and performing push of the at least one notification message in response to determining that the at least one notification message satisfies the corresponding display rule.

In a second aspect of the disclosure, an apparatus for notification message push is provided. The apparatus includes: a first determining module configured to determine, in response to a trigger for message display, whether a notification message is cached, the cached notification message remaining undisplayed for a target display period; a second determining module configured to determine, in response to determining that one or more notification messages are cached, whether at least one of the one or more cached notification messages satisfies a corresponding display rule; and an executing module configured to perform push of the at least one notification message in response to determining that the at least one notification message satisfies the corresponding display rule.

In a third aspect of the disclosure, an electronic device is provided. The electronic device includes at least one processor; and at least one memory coupled to the at least one processor and storing instructions for execution by the at least one processor. The instructions, when executed by the at least one processor, cause the electronic device to perform the method of the first aspect.

In a fourth aspect of the disclosure, a non-transitory computer-readable storage medium is provided. The non-transitory computer-readable storage medium has a computer program stored thereon, and the computer program is executable by a processor to implement the method of the first aspect.

In a fifth aspect of the disclosure, a computer program product is provided. The computer program product includes a computer program, and the computer program, when executed by a processor, implements the method according to the first aspect of the disclosure.

It should be understood that the contents described in this content section is not intended to limit the key features or important features of the embodiments of the disclosure, nor is it intended to limit the scope of the disclosure. Other features of the disclosure will become readily understood from the following description.

### BRIEF DESCRIPTION OF DRAWINGS

The above and other features, advantages, and aspects of various embodiments of the disclosure will become more apparent from the following detailed description taken in conjunction with the accompanying drawings. In the drawings, the same or similar reference numbers refer to the same or similar elements, wherein:

FIG. 1 illustrates a schematic diagram of an example environment in which embodiments of the disclosure may be implemented;

FIG. 2A illustrates a flowchart of a process for a registration of a notification message push service according to a conventional solution;

FIG. 2B illustrates a flowchart of a process for pushing a notification message according to a conventional solution;

FIG. 3 illustrates a flowchart of a process for pushing a notification message according to some embodiments of the disclosure;

FIG. 4 illustrates a schematic diagram of an example architecture for pushing a notification message according to some embodiments of the disclosure;

FIG. 5 illustrates a flowchart of an example process for caching a notification message according to some embodiments of the disclosure;

FIG. 6 illustrates a flowchart of a process for pushing a notification message according to some embodiments of the disclosure;

FIG. 7 illustrates a block diagram of an apparatus for pushing a notification message according to some embodiments of the disclosure; and

FIG. 8 illustrates a block diagram of an electronic device capable of implementing one or more embodiments of the disclosure.

### DETAILED DESCRIPTION

Embodiments of the disclosure will be described in more detail below with reference to the accompanying drawings. While certain embodiments of the disclosure are shown in the accompanying drawings, it should be understood that the disclosure may be implemented in various forms, and should not be construed as limited to the embodiments set forth herein, but rather, these embodiments are provided for a more thorough and complete understanding of the disclosure. It should be understood that the drawings and embodiments of the disclosure are for illustrative purposes only and are not intended to limit the scope of the disclosure.

In the description of the embodiments of the disclosure, the terms “including” and the like should be understood to include “including but not limited to”. The term “based on” should be understood as “based at least in part on”. The terms “one embodiment” or “the embodiment” should be understood as “at least one embodiment”. The term “some embodiments” should be understood as “at least some embodiments”. Other explicit and implicit definitions may also be included below.

Herein, unless explicitly stated, “in response to A” performs one step and does not imply that this step is performed immediately after “A”, but may include one or more intermediate steps.

It may be understood that the data involved in the technical solution (including but not limited to the data itself, and obtaining, using, storing or deleting of the data) should follow the requirements of the corresponding laws and regulations and related regulations.

It can be understood that before using the technical solutions disclosed in the embodiments of the disclosure, relevant users should be informed of a type, a usage range, a usage scenario, and the like of the information related to the disclosure in an appropriate manner according to relevant laws and regulations, and authorization from the relevant users should be obtained, wherein the relevant users may include any type of rights body, such as an individual, a business, and a group.

For example, when an active request of a user is received, prompt information is sent to the relevant user to explicitly prompt the relevant user, and the operation requested to be performed will need to obtain and use the information of the relevant user, so that the relevant user can autonomously select whether to provide information to software or hardware, such as an electronic device, an application, a server or a medium, executing the operation of the technical solution of the disclosure according to the prompt information.

As an optional but non-limiting implementation, in response to receiving an active request of the relevant user, a manner of sending prompt information to the relevant user may be, for example, a pop-up window, and the prompt information may be presented in a text manner in the pop-up window. In addition, the pop-up window may further carry a selection control for the user to select “agree” or “not agree” to provide information to the electronic device.

It may be understood that the foregoing processes of notification and obtaining a user authorization are merely illustrative, and do not constitute a limitation on implementations of the disclosure, and other manners of meeting related laws and regulations may also be applied to implementations of the disclosure.

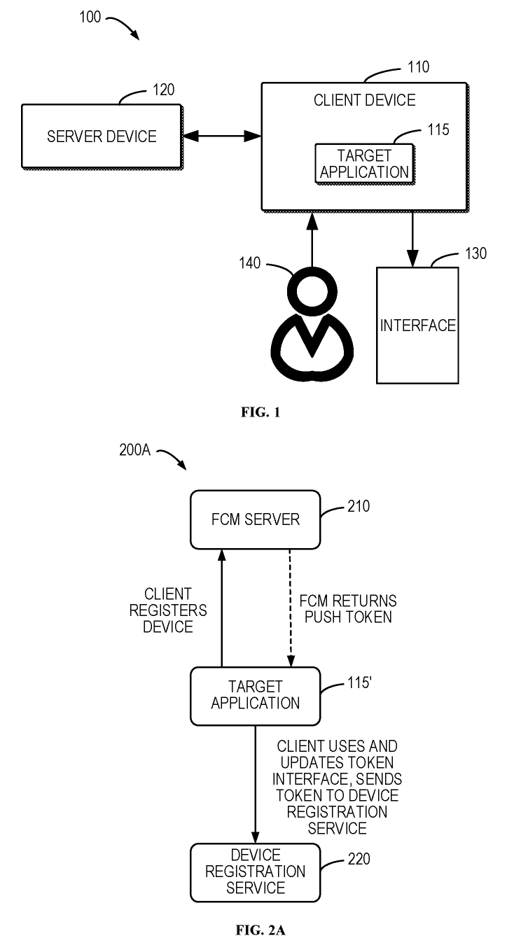

FIG. 1 illustrates a schematic diagram of an example environment 100 in which embodiments of the disclosure may be implemented. As shown in FIG. 1, the example environment 100 may include a client device 110 and a server device 120. In some embodiments, the client device 110 communicates with the server device 120 to implement various services including push of notification messages. In an application scenario related to notification message push, the server device 120 may generate and provide a service of a notification message to-be-pushed. The server device 120 may be considered a push content production end of the notification messages. The client device 110 may receive and display the notification message provided by the server device 120. In some embodiments, the client device 110 may display the notification message through an interface 130.

In this example environment 100, a target application 115 is installed in the client device 110. In some embodiments, the notification message provided by the server device 120 may include a notification message for the target application 115. In this scenario, the server device 120 may correspond to a server of the target application 115. In other embodiments, the notification message provided by the server device 120 may also include a notification message for an operating system of the client device 110. In this scenario, the server device 120 may correspond to a server of an operating system. Although only a single application is shown in FIG. 1, the client device 110 may be installed with more applications in practice, depending on the actual needs.

In some embodiments, the user 140 may view the displayed notification message through the interface 130 of the client device 110. In some embodiments, the user 140 may click the notification message through the interface 130 of the client device 110, or participate in interaction of the notification message in any other suitable manner.

In some embodiments, the client device 110 may be any type of mobile terminal, fixed terminal, or portable terminal, including a mobile phone, a desktop computer, a laptop computer, a notebook computer, a netbook computer, a tablet computer, a media computer, a multimedia tablet, a personal communication system (PCS) device, a personal navigation device, a personal digital assistant (PDA), an audio / video player, a digital camera / camcorder, a positioning device, a television receiver, a radio broadcast receiver, an electronic book device, a gaming device, or any combination of the foregoing, including accessories and peripherals of these devices, or any combination thereof. In some embodiments, the client device 110 may also support any type of interface for a user (such as a “wearable” circuit, etc.).

The server device 120 may be a standalone physical server, may be a distributed system or a server cluster composed of multiple physical servers, or may be a cloud server that provides basic cloud computing services such as cloud services, cloud databases, cloud computing, cloud functions, cloud storage, network services, cloud communications, middleware services, domain name services, security services, content distribution networks, and big data and artificial intelligence platforms. The server device 130 may include, for example, a computing system / server, such as a mainframe, an edge computing node, a computing device in a cloud environment, or the like.

It should be understood that the structures and functions of various elements in the environment 100 are described for illustrative purposes only and do not imply any limitation to the scope of the disclosure.

As briefly mentioned above, to enable the user to receive the required information through the client device, the notification message needs to be pushed to the client device reliably. Certainly, push of the notification message is mainly implemented by using a real-time push channel between the server and the client.

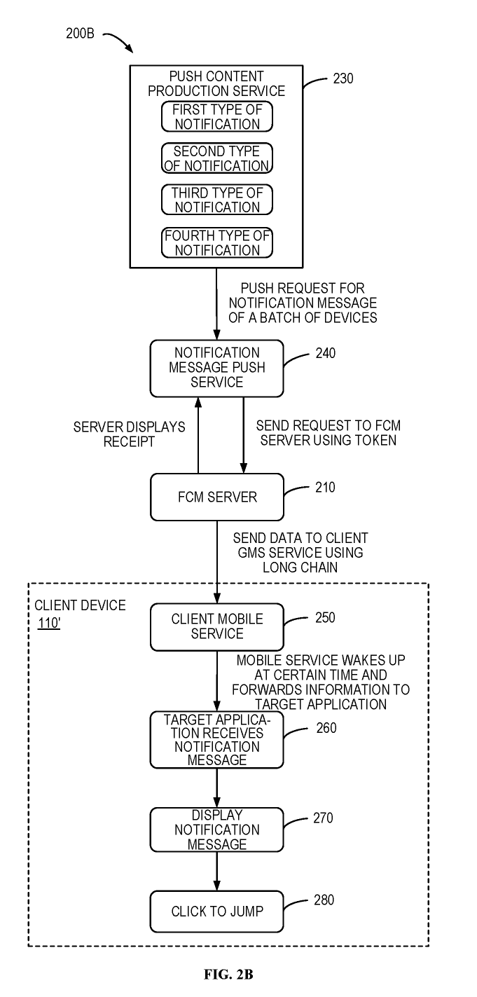

FIG. 2A illustrates a flowchart of a process 200A for a registration of a notification message push service according to a conventional real-time push channel solution. In the process 200A, first, the target application 115’ performs a device registration with the FCM server 210 through the client. The target application 115’ may be one example of the target application in the environment of FIG. 1. Specifically, the client may invoke an SDK (software development kit) to perform device registration. The FCM (firebase cloud messaging) server 210 may then return a token for implementing the message push to the target application 115’. The token may be used to identify the target application 115’. Thus, the target application 115’ obtains a corresponding token from the FCM server 210. The client may then send the token to the device registration service 220 using an update token interface. Thus, registration of the notification message push service may be completed.

FIG. 2B illustrates a flowchart of a process 200B for pushing a notification message according to a conventional real-time push channel solution. The push of the message notification implemented by the process 200B may push a service based on the notification message registered by the process 200A.

In the process 200B, the push content production service 230 may be a service for generating a notification message to be pushed. The notification to be pushed may include one or more types, such as a first type of notification, a second type of notification, a third type of notification, a fourth type of notification, and other more types of notification. Of course, the number of types of notification messages is not limited herein. For example, the first type of notification may include, for example, a content recommendation message pushed for the user, for example, to recommend various types of content that may be of interest to the user. The second type of notification may include, for example, an instant message (IM) between the users. The third type of notification may include, for example, interactive content, such as comments likes, user attentions, and the like on published content,. The fourth type of notification may include, for example, operational content related to the target application 115’, such as version upgrade, function improvement, and the like. It should be understood that multiple types of notification message may also include notification messages of other types and other content, and is not intended to limit the number of types of notification message herein.

The push content production service 230 may send a push request for notification messages for a batch of devices to the notification message push service 240. After receiving the request, the notification message push service 240 may send the request to the FCM server 210 through the token. After receiving the request, the FCM server 210 may display a receipt to a server of the notification message push service 240. The FCM server 210 may then utilize a long link to send related data about the notification message push to a mobile service 250 of the client device 110’ (a collection of a set of applications and services provided for the operating system of the client).

After receiving the data related to the notification message, the mobile service 250 of the client device 110’ may wake up the target application 115’ at a certain time, and forward the notification message to the target application 115’. After receiving the notification message (260), the target application 115’ may display a notification message (270) on an interface of the client device 110’. The client device 110’ may receive a click on the displayed notification message from the client, then jump (280) to the target application 115’ corresponding to the notification message, and display relevant content of the notification message on the target application 115’. Thus, push of the notification message is implemented through a real-time push channel.

The notification message is pushed through a solution of the real-time push channel, the entire push process is very long, and multiple nodes and services are involved. In the case of normal operation, the real-time push notification channel may ensure that the notification message can be displayed on the client device in time. However, if a certain service or link fails, the entire channel is affected. This results in a lower overall arrival rate of the notification message to the user. In addition, such a real-time push channel relies on a third-party service (for example, the notification message push service, the FCM server, etc.), it is usually difficult to optimize the real-time push channel, and it is difficult to ensure that a fault can be quickly repaired in the event of the fault. This results in difficulty in ensuring that the notification message can be reliably pushed to the user.

In view of this, embodiments of the disclosure provide an improved solution for pushing a notification message. According to various embodiments of the disclosure, in response to a trigger for message display, it is determined whether a notification message is cached, and the cached notification message is not displayed for a target display period. In response to determining that there is/are the cached notification message(s), determining whether at least one notification message of the cached notification message(s) satisfies a corresponding display rule. In response to determining that the at least one notification message satisfies the corresponding display rule, push of the at least one notification message is performed.

In this way, the notification message that may be used in the future may be cached locally on the client in advance, and after the trigger of message display is detected, the push of the notification message is determined according to the display rule corresponding to the cached notification message. This may enable more notification messages to be reliably displayed to the user, increasing the likelihood that the notification message is successfully displayed to the user. In some embodiments, the solution proposed by the disclosure can be used as a supplement to push the message notification with the conventional real-time push channel or other channel.

It should be understood that the structures and functions of various elements in the environment 100 are described for illustrative purposes only and do not imply any limitation to the scope of the disclosure.

Some example embodiments of the disclosure will be described below with continued reference to the accompanying drawings.

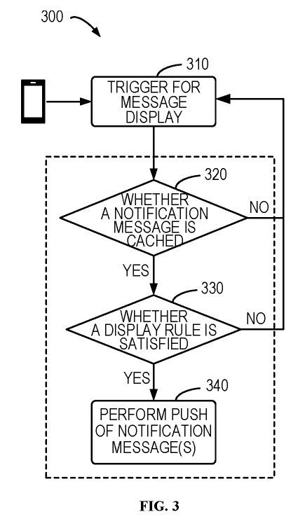

FIG. 3 illustrates a flowchart of a process 300 for pushing a notification message according to some embodiments of the disclosure. For ease of discussion, these embodiments will be described with reference to the environment 100 of FIG. 1. These embodiments may be implemented in the client device 110 of FIG. 1.

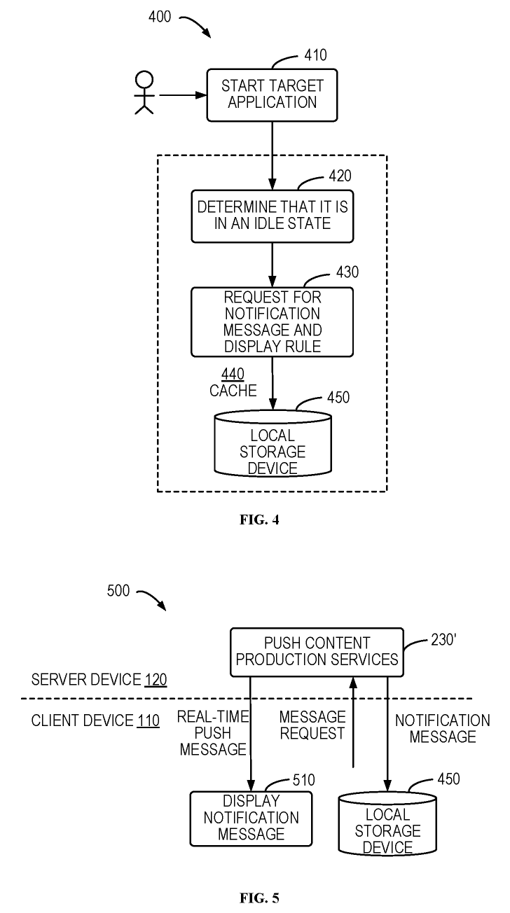

As shown in FIG. 3, at block 310, the client device 110 detects a trigger for message display. If the trigger for message display is detected, at block 320, the client device 110 determines whether there is a cached notification message. The cached notification message may be cached locally on the client device 110 in advance, for example, may be cached in a local storage device or database local to the client device 110. The caching of the notification message locally at the client device 110 will be discussed in detail below in connection with FIG. 4. In an embodiment of the disclosure, the cached notification message is not displayed in real time upon being received by the client device, but is not displayed for a target display period. The target display period herein may be, for example, a day, a half day, a week, or any other suitable period. It should be understood that the target display period may be set according to an actual situation, which is not limited herein.

If it is determined that there is no cached notification message, the client device 110 may return to the block 310 to continue detecting the trigger for message display. How the client device 110 may detect the trigger for message display will be discussed in detail below.

The trigger for message display refers to the client device 110 being triggered to determine whether to present a locally cached notification message. In some embodiments, if the client device 110 detects that no notification message is displayed for the target display period, or that the number of displayed notification messages does not reach a predetermined number, it may be determined that the trigger for message display is detected. For example, if the client device 110 detects that no notification message is displayed within one day or for other target display period, or the number of notification messages that have been displayed does not reach a predetermined number (e.g., 3 or other number), the message display may be triggered to determine whether to present a locally cached notification message.

In some embodiments, the notification message of the operating system or some application may also be pushed through the real-time push channel as shown in FIG. 2B. However, as discussed above, it is difficult to ensure the reliability of pushing the notification message through the real-time push channel, resulting in a lower reliability of the notification message reaching the client device 110 to be displayed. Therefore, there may be a situation in which no notification message is displayed for the target display period, or the number of notification messages that have been displayed does not reach a predetermined number. It should be understood that these situations may not only be caused by the real-time push channel, but may also be caused by other channels used to implement the message push. Thus, if these situations occur, it means that some push questions may occur in the real-time push channel, in order to continue to display a sufficient notification message to the user, the client device 110 may be triggered to display message and thus determine whether to push the locally cached notification message.

Alternatively or additionally, in some embodiments, if the client device 110 detects that a progress corresponding to the target application 115 is started, it may also be determined that the trigger for message display is detected. Here, at least one notification message to be displayed to the client device 110 may be associated with the target application 115. For example, the at least one notification message may be a notification message for the target application 115. As an example, the progress corresponding to the target application 115 may be a progress for triggering the message display that is separately started by the background of the client device 110. As another example, such a progress may also be a triggering process started based on detecting that the notification message is not displayed for the target display period, or that the number of notification messages that have been displayed does not reach a predetermined number.

With continued reference to FIG. 3, at block 330, if it is determined that there is/are cached notification message(s), the client device 110 determines whether at least one notification message of the cached notification message(s) satisfies a corresponding display rule. In some embodiments, for each notification message or each batch of notification messages in the cached notification message(s), the corresponding display rule may be configured. Since the notification message is not displayed in time after being received by the client device but is cached locally for a period of time, it may be constrained by configuring the display rule that the notification message may still suitable to be displayed to the user after a period of time of caching.

In some embodiments, the display rule is at least related to a cache duration of the notification message. As an example, the display rule related to the cache duration may be determined based on a message type of the notification message. For example, in general, for the content that the user 140 likes, the corresponding notification message, whether displayed on the first day or on the fifth day or at other times, is still in line with the content for preference of the user 140. Thus, for such a notification message of a personalized notification type, the user 140 may be pushed even if it is cached for a long time. For another example, for the content of the news summary type, since it has a certain timeliness, the corresponding notification message may be set to not be displayed to the user 140 beyond the predetermined cache duration. It should be understood that, for different types of notification messages, corresponding display rules related to the cache duration may be set according to actual conditions.

As another example, the display rule of the notification message may be determined based on a corresponding data security requirement. For example, for some notification messages, an overlong cache time may cause the notification message to be no longer suitable for being displayed to the user from the perspective of data security, and thus the cache duration may be set such that the notification message is not be displayed to the user 140 when its cache time exceeds a certain duration. It should be understood that different display rules related to data security requirements may be set for notification messages of different types or different contents.

In other examples, the display rule may also be determined based on other suitable factors. It should be understood that the display rule may be updated. For example, a display rule for the notification message may be added, a display rule that does not meet the current actual situation may be deleted, a display rule may also be modified, and the like.

With continued reference to FIG. 3, if it is determined that none of the cached notification message(s) satisfies the corresponding display rule, the client device 110 still returns to the block 310 to continue to detect the trigger for message display. In this case, it may be determined that no notification message in the cached notification message(s) conforms to the corresponding display rule based on a caching duration factor, a compliance risk factor, or other suitable factors.

If it is determined that at least one of the cached notification message(s) satisfies the corresponding display rule, at block 340, the client device 110 performs the push of the at least one notification message. Thus, the client device 110 may push the locally cached notification message capable of meeting the corresponding display rule for being displayed to the user 140. In this way, it can be ensured that the notification message may always be pushed to the user reliably, so that the user may obtain more information of interest, promoting the interaction participation of the user, and effectively improving the user experience.

In some embodiments, when performing the push of the at least one notification message, the client device 110 may determine the number of the at least one pushed notification message based on a difference between the predetermined number and the number of notification message(s) already displayed for the target display period. For example, it is assumed that three (or other predetermined number) of notification messages are to be displayed within the target display period (e.g., 1 day or other display periods), and if only two (or other number that is less than the predetermined number) of notification messages are displayed during this period, it may be determined that it is necessary to use the locally cached notification message to push one more (or other difference number of) notification message for the user 140. Thus, when the number of the notification message(s) that has/have been displayed does not reach the predetermined number, the difference in the number of the notification message(s) may be supplemented by the locally cached notification message.

Embodiments corresponding to the process of how the locally cached notification message is displayed are described above. FIG. 4 illustrates a flowchart of an example process 400 for caching a notification message according to some embodiments of the disclosure. The process 400 may be implemented in the environment 100 of FIG. 1. At least a portion of the notification message cached by the process 400 may be used to implement the notification message push of the process 300 of FIG. 3.

As shown in FIG. 4, at block 410, the client device 110 may detect that the target application 115 is started. The client device 110 may then detect whether the target application 115 is in an idle state. For example, the idle state of the target application 115 may include a state in which the target application 115 does not have user interaction activity within a period of time, with a relatively low system resource occupation, or is otherwise idle.

Further, at block 420, the client device 110 may determine that the target application 115 is in an idle state. At block 430, in some embodiments, if the target application 115 is in the idle state, the client device 110 may send a message request to the server device 120 to request the notification message and the corresponding display rule. In this way, the client device 110 may receive the notification message and the display rule corresponding to the notification message from the server device 120. Further, at block 440, the client device 110 may cache the received notification message and the corresponding display rule. As an example, the notification message and the corresponding display rule received by the client device 110 may be cached in a local storage device 450. The local storage device 450 may be any suitable device of the client device 110 that may be used to cache or store data. As another example, the notification message and the corresponding display rule received by the client device 110 may be cached in a database accessible to the client device 110.

Thus, the request and the cache of the notification message may be performed in the idle state of the application, avoiding the resource occupied when the user uses the target application, and reducing the influence on the user experience.

FIG. 5 illustrates a schematic diagram of an example architecture 500 for pushing a notification message according to some embodiments of the disclosure. The architecture 500 may be implemented in the environment 100 of FIG. 1. The architecture 500 may be illustrated as an architecture utilized by the process 300 of FIG. 3 and the process 400 of FIG. 4.

As shown in FIG. 5, in some embodiments, if the client device 110 receives a first notification message via a real-time push channel, push of the first notification message may be performed to display the first notification message (510). The first notification message may be generated by the push content production service 230’ of the server device 120. The push content production service 230’ may be a service in the server device 120 at least for generating a notification message. Here, the notification message received by the client device 110 through the real-time push channel is pushed in time.

However, as discussed above, in the real-time push channel, since the channel involves multiple service entities and the reliability of these service entities cannot be guaranteed, the reliability of the notification message being displayed to the client device 110 is affected. Thus, embodiments of the disclosure send a message request to the push content production service 230’ through the client device 110 to request at least the notification message. After receiving the message request, the push content production service 230’ may directly send the corresponding notification message to the client device 110, to cache the received notification message into the local storage device 450. Then, upon detecting the trigger for the message display, the client device 110 pushes the notification message that has been previously cached and satisfies the display rule to the user 140.

It should be noted that the notification message discussed herein may be an application level notification message or an operating system level notification message. The server device 120 may be a server device of an application (for example, the target application 115), or may be a server device of an operating system. It should be understood that the server device of the application or the server device of the operating system may include the push content production service 230’. When the client device 110 sends a message request to the server device 120, if the corresponding notification message is an operating system level notification message, the client device 110 may also determine an idle period of the operating system, and send the message request to the server device of the operating system within the idle period.

According to an embodiment of the disclosure, the notification message push may be implemented as a supplement to the real-time push channel pushing the notification message by using the cached notification message and the trigger for the message display and the display rule of the notification message. In some embodiments, the message push solution provided by the disclosure may also be used as a supplement to pushing notification messages through other third-party push channels other than the real-time push channel.

In some embodiments, if the first notification message is received from the server device 120 via the real-time push channel, the client device 110 may determine whether the first notification message is included in the cached notification message. If the first notification message is included in the cached notification message, the client device 110 may delete the first notification message from the cached notification message. That is, if the client device 110 has received the notification message from a conventional real-time push channel or other third-party push channel, the locally cached notification message needs to be deduplicated. This can avoid the same notification message being repeatedly displayed to the user, thereby improving the user experience.

According to the embodiment of the disclosure, the notification message which may be used in the future is cached to the local of the client in advance, and after the trigger for the message display is detected, the push of the notification message is determined according to the display rule corresponding to the cached notification message. This may enable more notification messages to be reliably displayed to the user, increasing the likelihood that the notification message is successfully displayed to the user. The solution provided by the disclosure may be used as a supplement to a conventional real-time push channel or other channel for pushing the notification message. This allows more notification messages to be reliably displayed to the user, increasing the reliability of the notification message to the user.

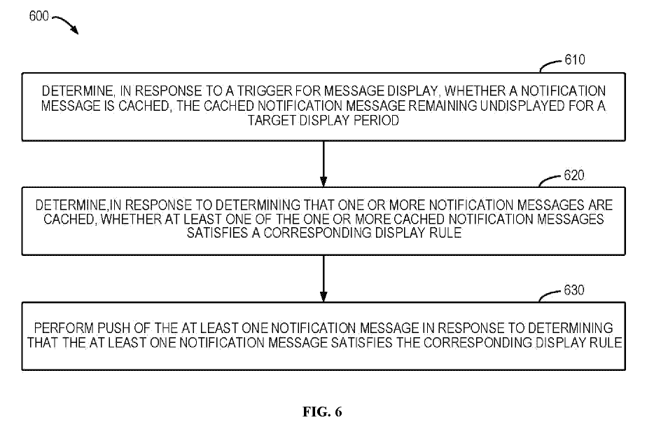

FIG. 6 shows a flowchart of a process 600 for pushing a notification message according to some embodiments of the disclosure. The process 600 may be implemented at the client device 110. The process 600 is described below with reference to FIG. 1.

As shown in FIG. 6, at block 610, the client device 110 determines, in response to a trigger for message display, whether a notification message is cached, the cached notification message being not displayed for the target display period.

At block 620, the client device 110 determines, in response to determining that one or more notification messages are cached, whether at least one of the one or more cached notification messages satisfies a corresponding display rule.

At block 630, the client device 110 performs push of the at least one notification message in response to determining that the at least one notification message satisfies the corresponding display rule.

In some embodiments, the process 600 further includes: sending a message request to a server device; receiving a notification message and a display rule corresponding to the notification message from the server; and caching the received notification message and the corresponding display rule.

In some embodiments, sending the message request to the server device includes: sending the message request to the server device in response to a target application being in an idle state.

In some embodiments, the process 600 further includes: determining that the trigger for the message display is detected in response to detecting at least one of the following: no notification message being displayed for the target display period, the number of displayed notification messages failing to reach a predetermined number, or a process corresponding to the target application being started and the at least one notification message being associated with the target application.

In some embodiments, the process 600 further includes: determining, in response to receiving a first notification message from a server device via a real-time push channel, whether the first notification message is included in the cached notification message; and deleting the first notification message from the cached notification message in response to determining that the first notification message is included in the cached notification message.

In some embodiments, the process 600 further includes: performing push of the first notification message in response to receiving the first notification message via the real-time push channel.

In some embodiments, the display rule is at least related to a cache duration of the notification message.

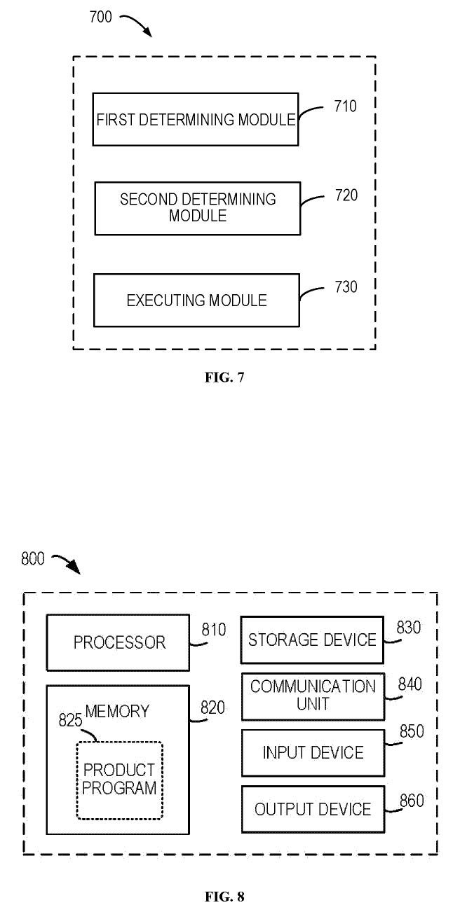

FIG. 7 is a schematic structural block diagram of an apparatus 700 for pushing a notification message according to some embodiments of the disclosure. The apparatus 700 may be implemented as or included in the client device 110. Various modules / components in the apparatus 700 may be implemented by hardware, software, firmware, or any combination thereof.

As shown in FIG. 7, the apparatus 700 includes: a first determining module 710 configured to determine, in response to a trigger for message display, whether a notification message is cached, the cached notification message being not displayed for a target display period; a second determining module 720 configured to determine, in response to determining that one or more notification messages are cached, whether at least one of the one or more cached notification messages satisfies a corresponding display rule; and an executing module 730 configured to perform push of the at least one notification message in response to determining that the at least one notification message satisfies the corresponding display rule.

In some embodiments, the apparatus 700 further includes a request module configured to send a message request to a server device; receive a notification message and a display rule corresponding to the notification message from the server device; and caching the received notification message and the corresponding display rule.

In some embodiments, the apparatus 700 is further configured to send the message request to the server device in response to a target application being in an idle state.

In some embodiments, the apparatus 700 further includes a triggering module configured to determine that the trigger for the message display is detected in response to detecting at least one of the following: no notification message being displayed for the target display period, the number of the displayed notification messages failing to reach a predetermined number, or a process corresponding to the target application being started, the at least one notification message being associated with the target application.

In some embodiments, the apparatus 700 further includes a deleting module configured to determine, in response to receiving a first notification message from a server device via a real-time push channel, whether the first notification message is included in the cached notification message; and delete the first notification message from the cached notification message in response to the first notification message being included in the cached notification message.

In some embodiments, the apparatus 700 further includes a real-time receiving module configured to perform push of the first notification message in response to receiving the first notification message via the real-time push channel.

In some embodiments, the display rule is at least related to a cache duration of the notification message.

The units and / or modules included in the apparatus 700 may be implemented in various manners, including software, hardware, firmware, or any combination thereof. In some embodiments, one or more units and / or modules may be implemented using software and / or firmware, such as machine-executable instructions stored on a storage medium. In addition to or as an alternative to machine-executable instructions, some or all of the units and / or modules in the apparatus 700 may be implemented, at least in part, by one or more hardware logic components. By way of example and not limitation, illustrative types of hardware logic components that may be used include field programmable gate arrays (FPGAs), application specific integrated circuits (ASICs), application specific standards (ASSPs), system-on-a-chip (SOCs), complex programmable logic devices (CPLDs), and the like.

FIG. 8 illustrates a block diagram illustrating an electronic device 800 in which one or more embodiments of the disclosure may be implemented. It should be understood that the electronic device 800 illustrated in FIG. 8 is merely illustrative and should not constitute any limitation on the functionality and scope of the embodiments described herein. The electronic device 800 shown in FIG. 8 may be configured to implement the client device 110 in FIG. 1 or the apparatus 700 in FIG. 7.

As shown in FIG. 8, the electronic device 800 is in the form of a general-purpose electronic device. Components of the electronic device 800 may include, but are not limited to, one or more processors or processing units 810, a memory 820, a storage device 830, one or more communication units 840, one or more input devices 850, and one or more output devices 860. The processor 810 may be an actual or virtual processor and capable of performing various processes according to programs stored in the memory 820. In a multiprocessor system, the plurality of processors execute computer-executable instructions in parallel to improve the parallel processing capability of the electronic device 800.

The electronic device 800 generally includes a plurality of computer storage media. Such media may be any available media accessible to the electronic device 800, including, but not limited to, volatile and non-volatile media, removable and non-removable media. The memory 820 may be a volatile memory (e.g., a register, a cache, a random access memory (RAM)), a non-volatile memory (e.g., read-only memory (ROM), an electrically erasable programmable read-only memory (EEPROM), a flash memory), or some combination thereof. The storage device 830 may be a removable or non-removable medium and may include a machine-readable medium, such as a flash drive, a magnetic disk, or any other medium, which may be capable of storing information and / or data (e.g., training data for training) and may be accessed within electronic device 800.

The electronic device 800 may further include additional removable / non-removable, volatile / non-volatile storage media/medium. Although not shown in FIG. 8, a disk drive for reading from or writing into a removable, nonvolatile magnetic disk (e.g., a “floppy disk”) and an optical disk drive for reading from or writing into a removable, nonvolatile optical disk may be provided. In these cases, each drive may be connected to a bus (not shown) by one or more data media interfaces. The memory 820 may include a computer program product 825 having one or more program modules configured to perform various methods or actions of various embodiments of the disclosure.

The communication unit 840 implements communication with other electronic device through a communication medium. Additionally, the functionality of components of the electronic device 800 may be implemented in a single computing cluster or multiple computing machines capable of communicating over a communication connection. Thus, the electronic device 800 may operate in a networked environment using logical connections with one or more other servers, network personal computers (PCs), or another network node.

The input device 850 may be one or more input devices such as a mouse, a keyboard, a trackball, or the like. The output device 860 may be one or more output devices, such as a display, a speaker, a printer, or the like. The electronic device 800 may also communicate with one or more external devices (not shown) through the communication unit 840 as needed, the external device such as a storage device, a display device, etc., communicates with one or more devices that enable a user to interact with the electronic device 800, or communicates with any device (e.g., a network card, a modem, etc.) that enable the electronic device 800 to communicate with one or more other electronic devices. Such communication may be performed via an input / output (I / O) interface (not shown).

According to example implementations of the disclosure, there is provided a computer-readable storage medium having computer-executable instructions stored thereon, and the computer-executable instructions are executed by a processor to implement the method described above. According to example implementations of the disclosure, a computer program product is further provided, the computer program product being tangibly stored on a non-transitory computer-readable medium and including computer-executable instructions, the computer-executable instructions being executed by a processor to implement the method described above.

Aspects of the disclosure are described herein with reference to flowcharts and / or block diagrams of a method, an apparatus, a device, and a computer program product implemented in accordance with the disclosure. It should be understood that each block of the flowchart and / or block diagram, and combination(s) of blocks in the flowchart(s) and / or block diagram(s), may be implemented by computer readable program instructions.

These computer-readable program instructions may be provided to a processor of a general purpose computer, special purpose computer, or other programmable data processing apparatus to produce a machine, such that the instructions, when executed by a processor of the computer or other programmable data processing apparatus, produce means to implement the functions / acts specified in one or more blocks in the flowchart(s) and / or block diagram(s). These computer-readable program instructions may also be stored in a computer-readable storage medium, and cause the computer, programmable data processing apparatus, and / or other devices to work in a particular manner, such that the computer-readable medium storing instructions includes an article of manufacture including instructions to implement aspects of the functions / acts specified in one or more blocks in the flowchart(s) and / or block diagram(s).

The computer-readable program instructions may be loaded onto the computer, other programmable data processing apparatus, or other apparatus, such that a series of operational steps are performed on the computer, other programmable data processing apparatus, or other apparatus to produce a computer-implemented process, such that the instructions executed on the computer, other programmable data processing apparatus, or other apparatus implement the functions / acts specified in one or more blocks in the flowchart(s) and / or block diagram(s).

The flowchart and block diagrams in the figures show architecture, functionality, and operation that may be possibly implemented by system(s), method(s), and computer program product(s) according to various implementations of the disclosure. In this regard, each block in the flowchart or block diagram may represent a module, program segment, or part of an instruction that includes one or more executable instructions for implementing the specified logical function. In some alternative implementations, the functions noted in the block(s) may also occur in a different order than noted in the figures. For example, two consecutive blocks may actually be performed substantially in parallel, which may sometimes be performed in the reverse order, depending on the functionality involved. It is also noted that each block in the block diagram and / or flowchart, as well as combination(s) of blocks in the block diagram(s) and / or flowchart(s), may be implemented with a dedicated hardware-based system that performs the specified functions or actions, or may be implemented in a combination of dedicated hardware and computer instructions.

Various implementations of the disclosure have been described above, which are illustrative, not exhaustive, and are not limited to the implementations disclosed. Many modifications and variations will be apparent to those of ordinary skill in the art without departing from the scope and spirit of the various implementations illustrated. The selection of the terms used herein is intended to best explain the principles of the implementations, practical applications, or improvements to techniques in the marketplace, or to enable others of ordinary skill in the art to understand the various implementations disclosed herein.

1. A method for notification message push, comprising:
determining, in response to a trigger for message display, whether a notification message is cached, the cached notification message remaining undisplayed for a target display period;
determining, in response to determining that one or more notification messages are cached, whether at least one of the one or more cached notification messages satisfies a corresponding display rule; and
performing push of the at least one notification message in response to determining that the at least one notification message satisfies the corresponding display rule.

2. The method of claim 1, further comprising:
sending a message request to a server device;
receiving a notification message and a display rule corresponding to the notification message from the server device; and
caching the received notification message and the corresponding display rule.

3. The method of claim 2, wherein sending the message request to the server device comprises:
sending the message request to the server device in response to a target application being in an idle state.

4. The method of claim 1, further comprising:
determining that the trigger for the message display is detected in response to detecting at least one of the following:
no notification message being displayed for the target display period,
the number of displayed notification messages failing to reach a predetermined number, or
a process corresponding to the target application being started, the at least one notification message being associated with the target application.

5. The method of claim 1, further comprising:
determining, in response to receiving a first notification message from a server device via a real-time push channel, whether the first notification message is comprised in the cached notification message; and
deleting the first notification message from the cached notification message in response to determining that the first notification message is comprised in the cached notification message.

6. The method of claim 5, further comprising:
performing push of the first notification message in response to receiving the first notification message via the real-time push channel.

7. The method of claim 1, wherein the display rule is at least related to a cache duration of the notification message.

8. An electronic device comprising:
at least one processor; and
at least one memory coupled to the at least one processor and storing instructions for execution by the at least one processor, the instructions, when executed by the at least one processor, causing the electronic device to perform acts comprising:
determining, in response to a trigger for message display, whether a notification message is cached, the cached notification message remaining undisplayed for a target display period;
determining, in response to determining that one or more notification messages are cached, whether at least one of the one or more cached notification messages satisfies a corresponding display rule; and
performing push of the at least one notification message in response to determining that the at least one notification message satisfies the corresponding display rule.

9. The electronic device of claim 8, wherein the acts further comprises:
sending a message request to a server device;
receiving a notification message and a display rule corresponding to the notification message from the server device; and
caching the received notification message and the corresponding display rule.

10. The electronic device of claim 9, wherein sending the message request to the server device comprises:
sending the message request to the server device in response to a target application being in an idle state.

11. The electronic device of claim 8, wherein the acts further comprises:
determining that the trigger for the message display is detected in response to detecting at least one of the following:
no notification message being displayed for the target display period,
the number of displayed notification messages failing to reach a predetermined number, or
a process corresponding to the target application being started, the at least one notification message being associated with the target application.

12. The electronic device of claim 8, wherein the acts further comprises:
determining, in response to receiving a first notification message from a server device via a real-time push channel, whether the first notification message is comprised in the cached notification message; and
deleting the first notification message from the cached notification message in response to determining that the first notification message is comprised in the cached notification message.

13. The electronic device of claim 12, wherein the acts further comprises:
performing push of the first notification message in response to receiving the first notification message via the real-time push channel.

14. The electronic device of claim 8, wherein the display rule is at least related to a cache duration of the notification message.

15. A non-transitory computer-readable storage medium having a computer program stored thereon which is executable by a processor to implement acts comprises:
determining, in response to a trigger for message display, whether a notification message is cached, the cached notification message remaining undisplayed for a target display period;
determining, in response to determining that one or more notification messages are cached, whether at least one of the one or more cached notification messages satisfies a corresponding display rule; and
performing push of the at least one notification message in response to determining that the at least one notification message satisfies the corresponding display rule.

16. The non-transitory computer-readable storage medium of claim 15, wherein the acts further comprises:
sending a message request to a server device;
receiving a notification message and a display rule corresponding to the notification message from the server device; and
caching the received notification message and the corresponding display rule.

17. The non-transitory computer-readable storage medium of claim 16, wherein sending the message request to the server device comprises:
sending the message request to the server device in response to a target application being in an idle state.

18. The non-transitory computer-readable storage medium of claim 15, wherein the acts further comprises:
determining that the trigger for the message display is detected in response to detecting at least one of the following:
no notification message being displayed for the target display period,
the number of displayed notification messages failing to reach a predetermined number, or
a process corresponding to the target application being started, the at least one notification message being associated with the target application.

19. The non-transitory computer-readable storage medium of claim 15, wherein the acts further comprises:
determining, in response to receiving a first notification message from a server device via a real-time push channel, whether the first notification message is comprised in the cached notification message; and
deleting the first notification message from the cached notification message in response to determining that the first notification message is comprised in the cached notification message.

20. The non-transitory computer-readable storage medium of claim 19, wherein the acts further comprises:
performing push of the first notification message in response to receiving the first notification message via the real-time push channel.
